(19) United States
(12) Patent Application Publication
(10) Pub. No.: US 2008/0291247 A1
(43) Pub. Date: Nov. 27, 2008

(54) DROPLET DISCHARGE HEAD, DROPLET DISCHARGE APPARATUS, AND METHOD FOR DISCHARGE CONTROL IN DROPLET DISCHARGE HEAD

(75) Inventors: Tomonori MATSUSHITA, Fujimi (JP); Junichiro SHINOZAKI, Chino (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/102,948

(22) Filed: Apr. 15, 2008

(30) Foreign Application Priority Data
May 22, 2007 (JP) 2007-135377

(51) Int. Cl. B41J 2/04; B41J 29/38

(52) U.S. Cl. 347/54; 347/9

(57) ABSTRACT

A droplet discharge includes: a nozzle discharging a liquid as a droplet; a discharge room having a diaphragm and disposed in a channel of the liquid, the channel communicating with the nozzle, the diaphragm pressurizing the liquid by being displaced and being a part of the discharge room; and a fixed electrode facing the diaphragm and generating electrostatic force with respect to the diaphragm by receiving electric charge so as to displace the diaphragm by bringing the diaphragm into contact with and detaching the diaphragm from the fixed electrode. The fixed electrode includes: a first fixed electrode received the electric charge from an outside; and a second fixed electrode made of a material different from a material of the first fixed electrode and received the electric charge through the first fixed electrode.

### BACKGROUND

1. Technical Field

The present invention relates to a droplet discharge head, a droplet discharge apparatus including the droplet discharge head, and the like.

2. Related Art

The micro-electro-mechanical systems (MEMS) technology for forming fine elements or the like by processing, for example, silicon has been rapidly advanced. Among micromachined elements formed using the MEMS technology are droplet discharge heads (inkjet heads) for use in a recording apparatus such as a droplet discharge type printer, micropumps, variable optical filters, electrostatic actuators such as motors, and pressure sensors.

Droplet discharge type (typified by inkjet used to perform printing by discharging ink) apparatus are used in all fields of printing, whether for consumer use or for industrial use. In a droplet discharge type apparatus, a micromachined element such as a droplet discharge head having multiple nozzles is moved relative to a target so as to discharge a liquid onto a predetermined position of the target. In recent years, droplet discharge type apparatuses are also used when manufacturing color filters for use in a liquid crystal display, display substrates using an organic electroluminescence element or an organic light-emitting diode (OLED), microallays of biomolecules such as deoxyribonucleic acids (DNAs), and the like.

Among discharge heads for realizing the droplet discharge type is one in which at least one wall, for example, a bottom wall (hereafter will be referred to as a “diaphragm” although it is formed integrally with other walls) of a discharge room for storing a discharge liquid flowing on a channel is previously made deformable and, by deforming the diaphragm to increase the pressure in the discharge room, a droplet is discharged from a nozzle communicating with the discharge room.

In an electrostatic type droplet discharge head, electrostatic force is generated between a diaphragm as a movable electrode and an individual electrode as a fixed electrode opposed to the diaphragm so that the diaphragm is attracted to the individual electrode. Subsequently, when the electrostatic force is weakened or its generation is stopped, restoring force (elastic force) that attempts to restore the diaphragm to its equilibrium position is exerted more strongly. Thus, the diaphragm returns to its original position. By repeating these operations, the diaphragm is driven so that a droplet is discharged. In this case, if various types of control are performed in the droplet discharge head in order to enhance the image quality and printing speed, it is convenient. Specifically, there are strong demands such as one for changing the amount of a droplet to be discharged (hereafter referred to as a “discharge amount”) onto each landing position or one for discharging droplets stably. For these reasons, an inkjet head has been proposed in which an individual electrode is divided into multiple ones, application of a voltage to each electrode is controlled, electrostatic force is changed according to the number of electrodes to which a voltage is applied so as to change the discharge amount (for example, see JP-A-2000-015801.)

However, as the density increasingly becomes higher, it is difficult to provide multiple individual electrodes and install wiring for each individual electrode. Also, the cost is increased due to such additional wiring.

### SUMMARY

An advantage of the invention is to obtain a droplet discharge head and the like that are allowed to change the discharge amount with a simple structure.

According to a first aspect of the invention, a droplet discharge head includes: a nozzle discharging a liquid as a droplet; a discharge room having a diaphragm and disposed in a channel of the liquid, the channel communicating with the nozzle, the diaphragm pressurizing the liquid by being displaced and being a part of the discharge room; and a fixed electrode facing the diaphragm and generating electrostatic force with respect to the diaphragm by receiving electric charge so as to displace the diaphragm by bringing the diaphragm into contact with and detaching the diaphragm from the fixed electrode. The fixed electrode includes: a first fixed electrode received the electric charge from an outside; and a second fixed electrode made of a material different from a material of the first fixed electrode and received the electric charge through the first fixed electrode.

According to the first aspect of the invention, the fixed electrode includes the first fixed electrode and the second fixed electrode that is made of a material different from the material of the first fixed electrode and receives electric charge via the first fixed electrode. Thus, by controlling the supply of electric charge to the fixed electrode, it is determined whether the diaphragm is brought into contact with only the first fixed electrode or it is brought into contact with both the first and second fixed electrodes, and then a discharge operation is performed. As a result, a droplet discharge head is obtained that is able to change the amount of a droplet to be discharged at one time. Such a droplet discharge head is easily manufactured since it does not have a complicated structure such as a stepped one.

In the droplet discharge head according to the first aspect of the invention, the first and second fixed electrodes are preferably electrically coupled to each other via one or more connectors that serve as an electric charge supply path from the first fixed electrode to the second fixed electrode.

According to the first aspect of the invention, the first and second fixed electrodes are electrically coupled to each other via one or more connectors. Thus, the electric charge supply path is arbitrarily prescribed. Specifically, by setting the number of connectors, widths thereof, or the like, the amount (time) of supply of electric charge from the first fixed electrode to the second fixed electrode is arbitrarily controlled.

In the droplet discharge head according to the first aspect of the invention, the second fixed electrode is preferably made of a material having an electrical resistivity higher than an electrical resistivity of a material of the first fixed electrode.

According to the first aspect of the invention, the second fixed electrode is made of a material having an electrical resistivity higher than an electrical resistivity of a material of the first fixed electrode. Thus, the time taken until electrostatic force required to bring the diaphragm into contact with the second fixed electrode is generated is increased compared with the time taken until electrostatic force required to bring the diaphragm into contact with the first fixed electrode is generated.

In the droplet discharge head according to the first aspect of the invention, indium tin oxide (ITO) is preferably used as a material of the first fixed electrode and titanium is preferably used as a material of the second fixed electrode.

According to the first aspect of the invention, the droplet discharge head has a long life and discharges droplets favorably since this combination of materials is the best one in terms of the difference between the electrical resistivities, adhesiveness in a case where a substrate serving as a base is made of glass, or the like. Also, titanium is resistant to an etchant (etching solution) necessary when etching ITO in the manufacturing process. Therefore, by previously forming the second individual electrode using titanium, the first and second fixed electrodes are easily formed on a substrate.

In the droplet discharge head according to the first aspect of the invention, chrome, platinum, or gold is preferably used as a material of the second fixed electrode instead of the titanium.

According to the first aspect of the invention, if chrome, platinum, or gold is used as the material of the second fixed electrode, a droplet discharge head that is good in electrical resistivity is obtained.

In the droplet discharge head according to the first aspect of the invention, the first fixed electrode is preferably disposed in a central part in a short side direction of the discharge room and the second fixed electrode is preferably disposed on both sides of the first fixed electrode, and the first fixed electrode and the second fixed electrode are preferably provided side by side along the short side direction of the discharge room.

According to the first aspect of the invention, the fixed electrode is provided along the short side direction of the discharge room. Therefore, the diaphragm is brought into contact with at least the first fixed electrode along the channel for a liquid, as has been done conventionally, so that a pressure necessary to discharge a droplet is applied. Also, since the second fixed electrode is provided on both sides of the first fixed electrode, the diaphragm is brought into contact with the fixed electrode with good balance.

In the droplet discharge head according to the first aspect of the invention, one or more fixed electrodes made of a material different from materials of the first and second fixed materials are preferably further provided outside the second fixed electrode in the short side direction of the discharge room.

According to the first aspect of the invention, one or more fixed electrodes are further provided outside the second fixed electrode. Therefore, the amount of a droplet to be discharged at one time is changed in three or more levels.

In the droplet discharge head according to the first aspect of the invention, the first fixed electrode and the second fixed electrode are preferably provided side by side along a long side direction of the discharge room.

According to the first aspect of the invention, the first fixed electrode and the second fixed electrode are side by side along the long side direction of the discharge room. Thus, a droplet discharge head is obtained that changes the amount of a droplet to be discharged at one time at multiple levels even if these fixed electrodes are provided side by side in the long side direction.

According to a second aspect of the invention, a droplet discharge apparatus includes the above-described droplet discharge head.

According to the second aspect of the invention, the droplet discharge apparatus includes the above-described droplet discharge head. Therefore, the structure of the droplet discharge head becomes simple and the amount of a droplet to be discharged at one time is changed by simply controlling the voltage application time. As a result, image quality is enhanced, for example, when images are printed.

According to a third aspect of the invention, a discharge control method for a liquid discharge head including: a nozzle discharging a liquid as a droplet; a discharge room having a diaphragm and disposed in a channel of the liquid, the channel communicating with the nozzle, the diaphragm pressurizing the liquid by being displaced and being a part of the discharge room; and a fixed electrode facing the diaphragm and generating electrostatic force with respect to the diaphragm by receiving electric charge so as to displace the diaphragm by bringing the diaphragm into contact with and detaching the diaphragm from the fixed electrode, the fixed electrode including a first fixed electrode received the electric charge from an outside and a second fixed electrode that is made of a material different from a material of the first fixed electrode and received the electric charge through the first fixed electrode, the method includes controlling a time during which a voltage is applied by supplying electric charge to the fixed electrode, so that an area of contact of the diaphragm with the fixed electrode is changed.

According to the third aspect of the invention, by simply controlling the time during which a voltage is applied by supplying electrical charge to the fixed electrode, it is determined whether the diaphragm is brought into contact with only the first fixed electrode or it is brought into contact with both the first and second fixed electrodes, and then a discharge operation is performed. That is, the discharge amount of a droplet is changed by performing simple control.

In the discharge control method for a droplet discharge head according to the third aspect of the invention, a time during which a voltage is applied between the diaphragm and the fixed electrode is preferably set according to respective time constants of the first and second fixed electrodes related to accumulation of electricity.

According to the third aspect of the invention, the time during which a voltage is applied between the diaphragm and the fixed electrode is set according to the time constants related to accumulation of electricity. This allows efficient design.

### BRIEF DESCRIPTION OF THE DRAWINGS

The invention will be described with reference to the accompanying drawings, wherein like numbers reference like elements.

FIG. 1 is an exploded view of a droplet discharge head according to a first embodiment of the invention.

FIG. 2 is a sectional view of the droplet discharge head according to the first embodiment.

FIG. 3 is a diagram showing a configuration centering on a drive control circuit 40.

FIG. 4 is a partial enlarged view of a recess 11 and an individual electrode 12.

FIGS. 5A to 5C are diagrams showing relations between the voltage application time and the contact of a diaphragm 22.

FIGS. 6A and 6B are diagrams showing example relations between the width of the individual electrode 12 and time constants.

FIGS. 7A to 7J are drawings showing a process of manufacturing an electrode substrate 10.

FIGS. 8A to 7G are drawings showing a process of manufacturing the droplet discharge head.

FIG. 9 is a partial enlarged view of the recess 11 and individual electrode 12.

FIG. 10 shows a table showing a typical electrical resistivity of each metal.

FIG. 11 is a partial enlarged view of the recess 11 and individual electrode 12.

FIG. 12 is an outline view of a droplet discharge apparatus using the droplet discharge head.

FIG. 13 is a drawing showing one example of the main components of the droplet discharge apparatus.

### DESCRIPTION OF EXEMPLARY EMBODIMENTS

### First Embodiment

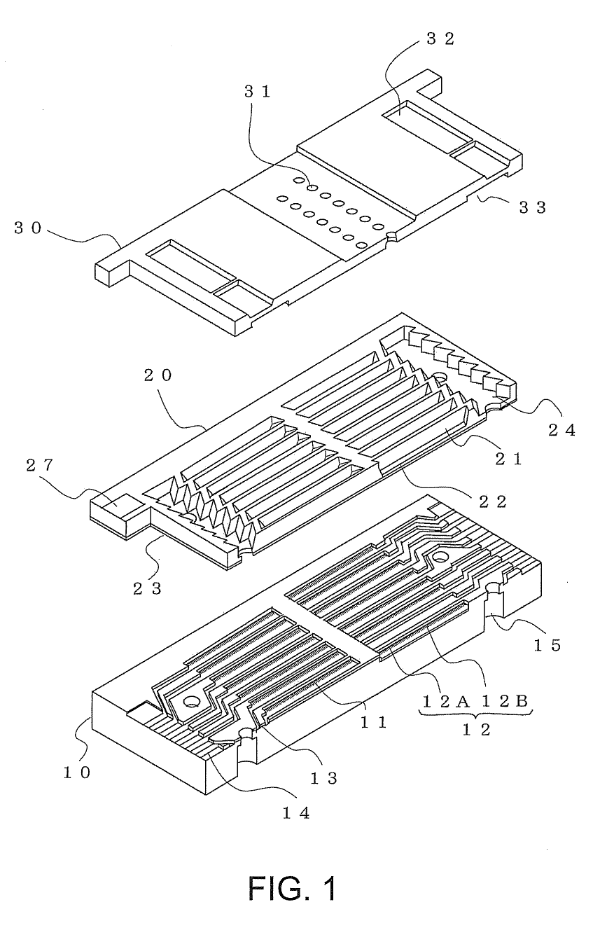

FIG. 1 is an exploded view of a droplet discharge head according to a first embodiment of the invention and shows a part of the droplet discharge head (the droplet discharge head actually has nozzles more than ones shown in FIG. 1). In this embodiment, a “face eject” type droplet discharge head will be described as a typical example of a device in which an electrostatically-driven actuator is used. Note that in order for the components to be seen easily, the size relations among the components in the following drawings including FIG. 1 may differ from actual ones. An upper side of each drawing will be referred to as “upper” and a lower side thereof as “lower.” Since the direction in which nozzles are arranged is a direction of a short side of a rectangular discharge room 21 (a diaphragm 22 and an individual electrode 12), this direction will be referred to as a “short side direction,” and a direction orthogonal to the short side direction as a “long side direction.”

As shown in FIG. 1, the droplet discharge head according to this embodiment is formed by laminating three substrates, an electrode substrate 10, a cavity substrate 10 and a nozzle substrate 30, in ascending order. In this embodiment, the electrode substrate 10 and cavity substrate 20 are anodically bonded to each other. The cavity substrate 20 and nozzle substrate 30 are bonded together using an epoxy adhesive or the like.

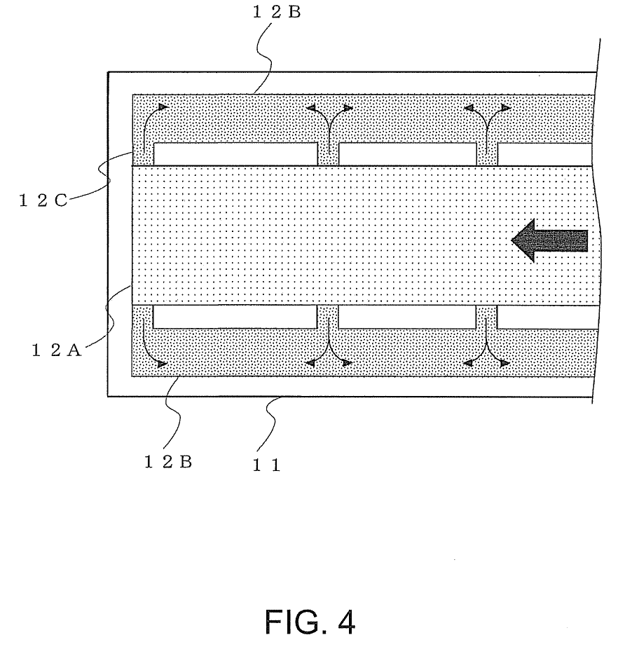

The electrode substrate 10 is mainly made of, for example, a borosilicate and heat-resistant hard glass with a thickness of approximately 1 mm. While a glass substrate is used as the electrode substrate 10 in this embodiment, a monocrystal silicon may be used, for example. On a surface of the electrode substrate 10, multiple recesses 11 having a depth of, for example, approximately 0.3 μm are formed in alignment with recesses that will become discharge rooms 21 of the cavity substrate 20 to be described later. Individual electrodes 12 as fixed electrodes are provided on the respective inner surfaces of (in particular, on the bottoms) of the recesses 11 in a manner that the individual electrodes are opposed to the discharge rooms 21 (diaphragms 22) of the cavity substrate 20. Here, each individual electrode 12 according to this embodiment includes a first individual electrode 12A and a second individual electrode 12B, each of which is made of a different material, and a connector 12C (see FIG. 4). The first individual electrode 12A is provided in the center of a rectangular portion inside each recess 11 in the short side direction, and the second individual electrodes 12B are provided on both sides of the first individual electrode 12A. The first individual electrode 12A and second individual electrode 12B are coupled at multiple locations via the connector 12C. A lead 13 and a terminal 14 both for electrically coupling an each individual electrode 12 and an external electric charge supply are provided in each recess 11 in a manner that the lead and terminal are integral with the first individual electrode 12A (these components will collectively be referred to as an “individual electrode 12” unless there is a need for referring to these components separately). The individual electrode 12 will be described in detail later.

Here, a gap in which the diaphragm 22 becomes deformed (displaced) and that has a given size is formed between the diaphragm 22 and individual electrode 12 inside the recess 11. The size of the gap formed between the diaphragm 22 (insulating film 23) and individual 12 will be referred to as a “gap length.” Also, the electrode substrate 10 has a through hole serving as a liquid supply inlet 15 for taking in a liquid provided from an external tank (not shown).

The cavity substrate 20 is mainly made of, for example, a silicon monocrystal substrate (hereafter referred to as a “silicon substrate”), a surface of which has a (110) orientation. The cavity substrate 20 has recesses (whose bottom wall is the diaphragm 22 serving as a movable electrode) serving as the discharge rooms 21 for temporarily storing a liquid to be discharged, and a recess serving as a reservoir 24. Also, an insulating film 23 that is intended to electrically insulate the cavity substrate 20 from the individual electrode 12 and made of a TEOS film (here, an oxide silicon (SiO₂) film formed using tetraethyl orthosilicate tetraethoxysilane (ethyl silicate) as a raw material gas) is formed in a thickness of 0.1 μm on the undersurface (surface opposed to the electrode substrate 10) of the cavity substrate 20. Al₂O₃ (aluminum (alumina) oxide) or the like may be used instead of the TEOS film in order to form the insulating film 23. In the following description, it will be assumed that the diaphragm 11 and insulating film 23 are integral with each other, unless otherwise mentioned. Also, the cavity substrate 20 has a recess serving as the reservoir (common liquid room) 24 for providing a liquid to each discharge room 21. Further, the cavity substrate 20 has a common electrode terminal 27 serving as a terminal used when electrical charge is supplied to the cavity substrate 20 (diaphragm 22) from an external power supply (not shown).

The nozzle substrate 30 is also mainly made of, for example, a silicon substrate. The nozzle substrate 30 has multiple nozzles 31. Each nozzle 31 discharges a liquid pressurized due to displacement of the diaphragm 22, as a droplet to outside. Also, the nozzle substrate 30 has an orifice 32 serving as a channel for causing the discharge room 21 and reservoir 24 to communicate with each other, and a diaphragm 33 for absorbing a pressure applied in a direction of the reservoir 24 due to deformation of the diaphragm 22.

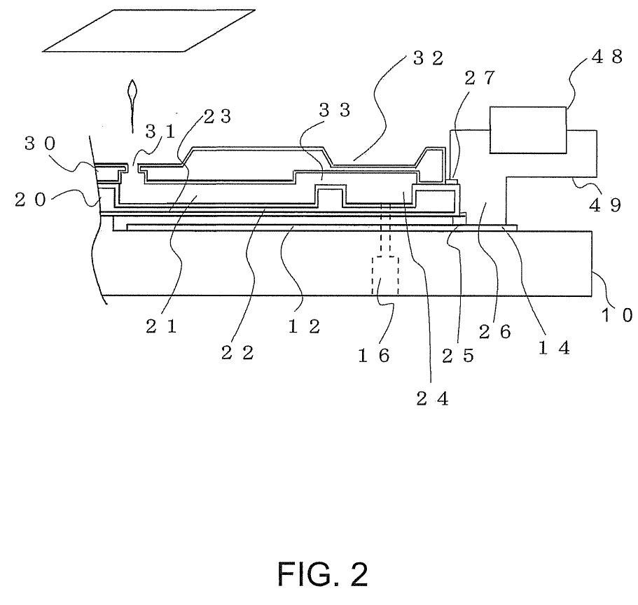

FIG. 2 is a sectional view of the droplet discharge head in the long side direction. In FIG. 2, the discharge room 21 stores a liquid to be discharged from the nozzle 31. By deforming the diaphragm 22 that is a bottom wall of the discharge room 21, the pressure in the discharge room 21 is increased so that a droplet is discharged from the nozzle 31. In this embodiment, the diaphragm 22 is formed by forming, on a silicon substrate, a high-concentration boron dope layer that can serve as an electrode and is favorably used in a wet-etching step. Also, in order to prevent a foreign object, moisture (water vapor), or the like from entering the gap, a sealing material 25 for shielding the gap from an external air and sealing the gap is provided on an electrode inlet 26.

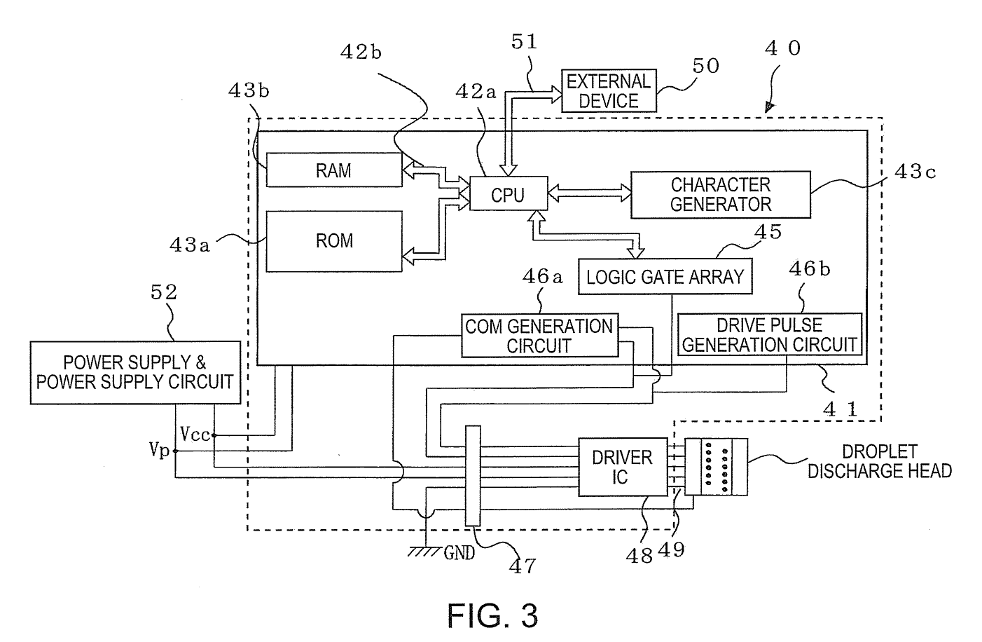

FIG. 3 is a diagram showing a configuration centering on a drive control circuit 40. A controller and the like that control the contact (hold) and detachment of the diaphragm 22 and perform control for discharging a droplet from the droplet discharge head will be described with reference to FIG. 3. The drive control circuit 40 includes a head controller 41 configured centering on a CPU 42a. The CPU 42a of the head controller 41 receives a signal including printing data from an external device 50 such as a computer via a bus 51.

The head controller 41 includes a ROM 43a, a RAM 43b, and a character generator 43c, and is coupled to the CPU 42a via an internal bus 42b. The CPU 42a perform a process according to a control program stored in the ROM 43a to generate a discharge control signal corresponding to printing data. At that time, the CPU 42a uses a memory area in the RAM 43b as a work area. Also, when printing characters or the like, the CPU 42a performs a process according to character data or the like stored in the character generator 43c. A discharge control signal generated by the CPU 42a is transmitted to a logic gate array 45 via an internal bus 42b. The logic gate array 45 generates a SEG signal concerning supply of electric charge to each individual electrode 12 provided for each nozzle 31, as will be described later, according to the discharge control signal. Also, a COM generation circuit 46a generates a COM signal concerning supply of electric charge to the cavity substrate 20 (diaphragm 22), as will be described later. A drive pulse generation circuit 46b generates a signal for synchronization. These signals are transmitted to a driver IC 48 via a connector 47.

The driver IC 48 is electrically coupled to the terminal 14 and the common electrode terminal 27 directly or via wiring 49 such as a flexible print circuit or a wire. If the number of terminals of the driver IC 48 is smaller than that of the nozzles 31, multiple driver ICs 48 may be provided. The driver IC 48 is a means for, upon receiving power from the power supply circuit 52, applying a voltage (drive voltage) between the diaphragm 22 and individual electrode (that is, making a potential difference therebetween) 12 by actually supplying (charging) electric charge to the cavity substrate 20 (diaphragm 22) and/or individual electrode 12, holding the supplied electric charge, and discharging (hereafter referred to as “output”) the cavity substrate and/or individual electrode, according to the above-described signals. By repeating such output, a voltage to be applied by output produced by the drive IC 48 comes to have a waveform of a pulse (actually, the voltage comes to have a waveform of a trapezoid since none of the rise time and fall time is zero; however, such output will be referred to as a “pulse” for convenience).

By applying a voltage by supplying electric charge, electrostatic force is generated between the diaphragm 12 and individual electrode 12. Thus, the diaphragm 22 is attracted to the individual electrode 12 so that it is deformed and brought into contact with the individual electrode 12. For this reason, the removal volume (volume of the discharge room 21) is increased. Conversely, if the potential difference between the diaphragm 22 and individual electrode 12 is eliminated or reduced by discharging the diaphragm 22 and individual electrode 12, generation of the electrostatic force is stopped or reduced. If the restoring force of the diaphragm 22 becomes larger than the force by which the diaphragm 22 is attracted, the diaphragm 22 attempts to return to its original position, thereby detaching itself from the individual electrode 12. A pressure (hereafter referred to as a “restoring pressure”) caused by this restoring force is applied to a liquid. Thus, the liquid is pushed out of the nozzle 31 so that a droplet is discharged. This droplet lands on, for example, recording paper that is a recording target. Thus, recording such as printing is performed.

FIG. 4 is a partial enlarged view of the recess 11 and individual electrode 12. As described above, the first individual electrode 12A and second individual electrode 12B, each of which is made of a different material, are formed inside each recess 11. In this embodiment, indium tin oxide (ITO) that is formed by doping indium oxide with tin oxide and is transparent in a visible light area is used as the material of the first individual electrode 12A (lead 13 and terminal 14). On the other hand, titanium (Ti) is used as the materials of the second individual electrode 12B and connector 12C. Although it varies with conditions such as the temperature, the electrical resistivity of titanium is typically 5.5×10⁻⁵ (Ω·cm) and higher than that of ITO. The widths of the first individual electrode 12A and second individual electrode 12B are not specified herein. However, since a larger width makes the electrical resistivity lower, electric charge more rapidly extends across the first individual electrode 12A if the first individual electrode 12A has a larger width. This is preferable in terms of discharging a droplet with a faster response. Consideration must be given to the balance between the width of contact of the diaphragm 22 with the first individual electrode 12A and that of the diaphragm 22 with the second individual electrodes 12B.

In this embodiment, three connectors 12C are provided. The first individual electrode 12A and second individual electrode 12B are electrically coupled to each other via the connectors 12C. Electrical charge from the driver IC 48 is supplied to the first individual electrode 12A via the terminal 14 and lead 14, and extends across the first individual electrode 12A. If the electric charge continues to be supplied from the driver IC 48, it is also supplied to the second individual electrode 12B via the first individual electrode 12A and the connectors 12C. Since supply of the electric charge to the second individual electrode 12B is performed via the first individual electrode 12A and connectors 12C and since the electrical resistivity of the second individual electrode 12B is higher than that of the first individual electrode 12A, it takes time until electric charge that causes electrostatic force that brings the diaphragm 22 into contact with the second individual electrode 12B extends across the second individual electrode 12B.

Here, if the first and second individual electrodes 12A and 12B are in contact with each other in a larger area, an electric charge supply path from the first individual electrode 12A to the second individual electrode 12B is widen. Thus, no difference may be made between the time taken until electric charge extends across the second individual electrode 12B and the time taken until electric charge extends across the first individual electrode 12A. For this reason, the connectors 12C are provided to limit the path through which electric charge is supplied from the first individual electrode 12A to second individual electrode 12B. Thus, a difference is made between the above-described times. However, if the contact area is reduced too much, it takes too much time until electric charge extends across the second individual electrode 12B. This may deteriorate responsiveness. Therefore, if an attempt is made to set a difference between the time taken until electric charge extends across the first individual electrode 12A and the time taken until electric charge extends across the second individual electrode 12B, the widths of the connectors 12C, the number thereof, or the like are adjusted. For example, the time difference is preferably approximately 2 μs. Here, since electric charge does not instantly extend across the first individual electrode 12A but it is supplied from a region close to the lead 13 and terminal 14 toward a region distant therefrom as described above, the time difference may vary slightly depending on the locations at which the connectors 12C are provided.

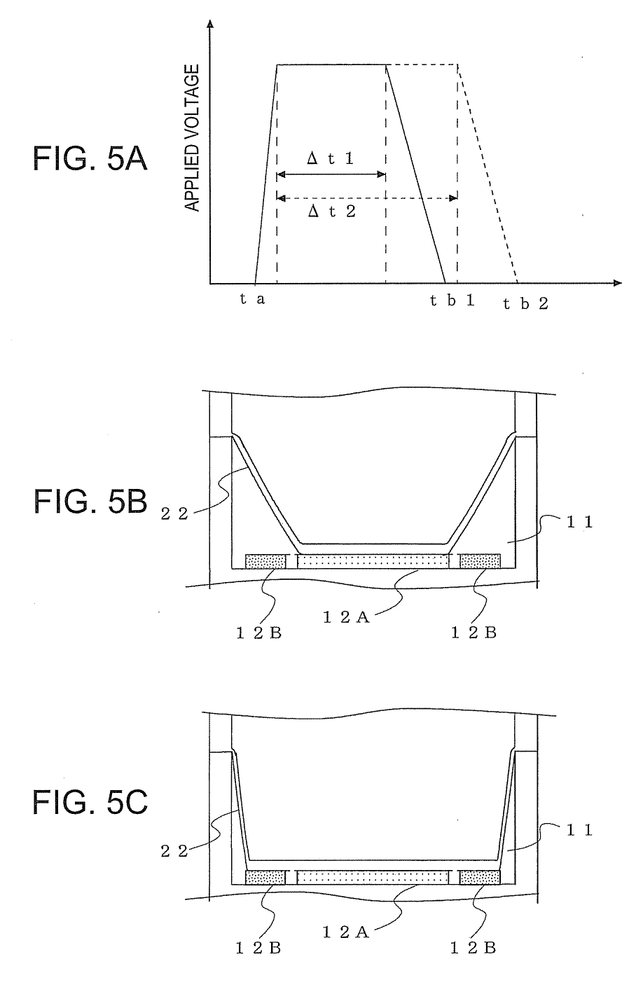

FIGS. 5A to 5C are diagrams showing a relation between the time during which a voltage is applied and the contact of the diaphragm 22. FIG. 5A shows a pulse waveform of a voltage to be applied by the driver IC 48. Here, the voltage of a COM signal to the common electrode terminal 27 is defined as GND, and the voltage of a SEG signal to be applied to control supply of electric charge to each of the individual electrodes 12 is defined as V. In this embodiment, as shown in FIG. 5A, the time (time during which a voltage is applied) during which electric charge is supplied is changed by the driver IC 48. Also, with regard to the time taken until electrostatic force that brings the diaphragm 22 into contact with the first individual electrode 12A and second individual electrode 12B is obtained, a difference is made between the first individual electrode 12A and second individual electrode 12B. This difference is made by forming the first and second individual electrodes 12A and 12B using different materials so that the respective individual electrodes have different electrical resistivities. Thus, whether the diaphragm 22 is brought into contact with only the first individual electrode 12A (FIG. 5B) or it is brought into contact with the entire individual electrode 12 (first individual electrode 12A, second individual electrode 12B, and connectors 12C) (FIG. 5C) is determined by adjusting the time during which electric charge is supplied. By changing the area (hereafter referred to as a “contact area”) in which the diaphragm 11 is in contact with the individual electrode 12 so as to change the removal volume (volume of the discharge room 21), the amount of a droplet to be discharged from the nozzle 31 is changed.

The driver IC 48 starts to apply a voltage at time ta. If the applied voltage is maintained at V during ≢t1, only the first individual electrode 12A accumulates electric charge that causes electrostatic force required to bring the diaphragm 22 into contact with the first individual electrode 12A (the second individual electrode 12B does not accumulate electric charge required to bring the diaphragm 22 into contact with the second individual electrode 12B). By discharging the individual electrode 12 after the diaphragm 22 has been brought into contact with the first individual electrode 12A, the diaphragm 22 is detached from the first individual electrode 12A. A droplet is discharged from the nozzle 31 by a restoring pressure caused at this time.

On the other hand, if the applied voltage is maintained at V during Δt2, the second individual electrodes 12B as well as the first individual electrode 12A accumulates electric charge that causes electrostatic force required to bring the diaphragm 22 into contact with the second individual electrodes 12B. By discharging the individual electrode 12 after the diaphragm 22 has been brought into contact with both the first and second individual electrodes 12A and 12B in this manner, the diaphragm 22 is detached from the individual electrode 12. A droplet is discharged from the nozzle 31 by a restoring pressure caused at this time. Since the diaphragm 22 has also been brought in contact with the second individual electrode 12B, the removal volume is increased. As a result, the amount of a droplet to be discharged from the nozzle 31 is increased compared with that in a case where the applied voltage is maintained at V.

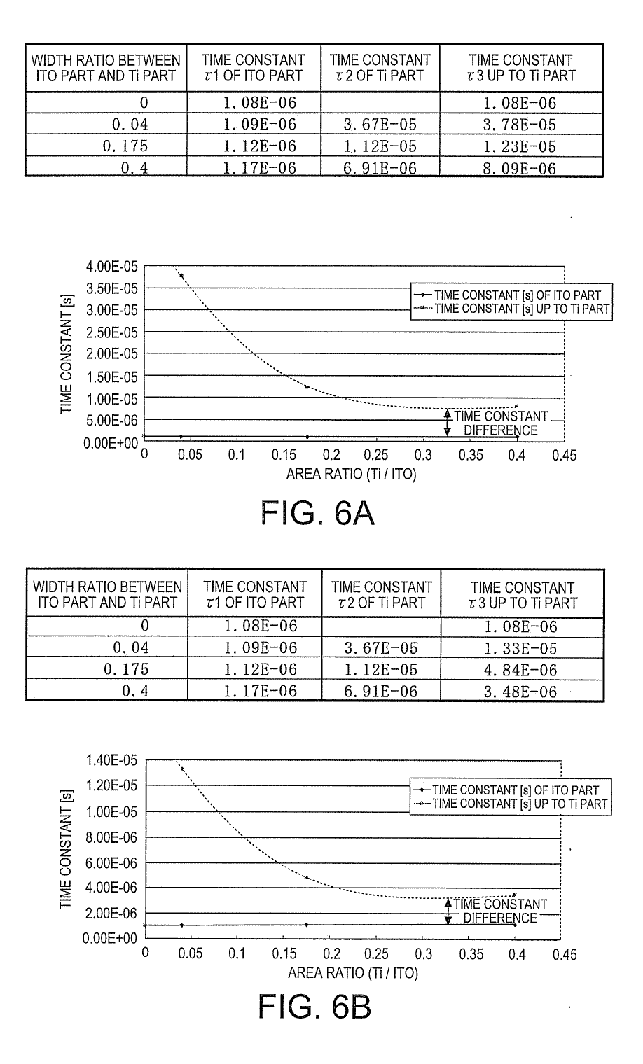

FIGS. 6A and 6B are diagrams showing an example relation between the widths of the first and second individual electrodes 12A and 12B and the time constants thereof. Specifically, FIGS. 6A and 6B show the ratio between the widths of the first individual electrode 12A made of ITO (referred to as an “ITO part” in FIGS. 6A and 6B) and second individual electrodes 12B made of titanium (referred to as a “Ti part” in FIGS. 6A and 6B), a time constant τ1(s) of the first individual electrode 12A (ITO part), a time constant τ2(s) of the second individual electrode 12B (Ti part), and a time constant τ3 (considered as the sum of the time constant τ1(s) and time constant τ2(s)) up to the second individual electrode 12B via the first individual electrode 12A. FIG. 6A shows a case where the first and second individual electrode 12A and 12B are electrically coupled to each other at one connector 12C. FIG. 6B shows a case where these electrodes are electrically coupled to each other at three connectors 12C. Note that the first and second individual electrode 12A and 12B have identical lengths.

Here, the time constant τ denotes a value showing a primary frequency response in a linear system expressed by the following Formula 1 and typically denotes the time taken until approximately 63.2% of a final value is reached.

e(t)=E(1−exp(−t/τ)) Formula 1

where e is a voltage between the diaphragm 11 and individual electrode 12, E is a voltage V applied by the driver IC 48, t is a time, and τ is a time constant.

In this embodiment, the time taken until approximately 63.2% of electric charge that can be accumulated in the first individual electrode 12A is accumulated and the time taken until approximately 63.2% of electric charge that can be accumulated in the second individual electrode 12B is accumulated are denoted as τ1 and τ2, respectively. It is conceivable that it takes a time longer than a time shown as the time constant until electric charge required to generate electrostatic force is supplied to the first individual electrodes 12A and second individual electrode 12B and accumulated therein, although it depends on the discharge amount, discharge speed, performance design items, and the like. For example, it is conceivable that when electrostatic force required to make contact is generated at triple the constant, approximately 95% of electric charge that can be accumulated is accumulated. In this case, the times are denoted by Δt1 and Δt2 shown in FIG. 5A. Thus, the time constants of the first and second individual electrodes 12A and 12B can be referred to, although the time constants are not used as the voltage application time directly. By setting the voltage application time according to the time constants, efficient design is achieved.

As described above, according to the first embodiment, the individual electrode 12 includes the first individual electrode 12A made of ITO and the second individual electrode 12B that is made of titanium and receives electric charge via the first individual electrode 12A. Thus, by controlling supply of electric charge from the driver IC 48, it is determined whether the diaphragm 22 is brought into contact with only the first individual electrode 12A or it is brought into contact with the both the first and second individual electrode 12A and 12B, and then a discharge operation is performed. As a result, the discharge amount of a droplet to be discharged at one time is changed. In this case, since the first and second individual electrode 12A and 12B are electrically coupled to each other via one or more (here, three) connectors, the electric charge supply path from the first individual electrode 12A to the second individual electrode 12B is arbitrarily set. Also, since the individual electrode 12 is provided along the short side direction of the discharge room 21 (diaphragm 22), the diaphragm 22 for applying a pressure required for discharge to a liquid is brought into contact with the individual electrode 12 along the channel of the liquid.

Also, since the first individual electrode 12A is made of ITO and the second individual electrode 12B is made of titanium that is a material having a electrical resistivity higher than ITO, a difference is made between the time taken until electrostatic force required to bring the diaphragm 22 into contact with the first individual electrode 12A is generated and the time taken until electrostatic force required to bring the diaphragm 22 into contact with the second individual electrode 12B is generated. In particular, the combination of ITO and titanium is the best one in terms of the difference between the electrical resistivities, adhesiveness in a case where a substrate serving as a base is made of glass, or the like. Thus, the droplet discharge head has a long life and performs favorable discharge.

Further, the time during which a voltage is applied by supplying electric charge to the individual electrode 12 is simply controlled by the drive IC 48, whereby the discharge amount is controlled. That is, the amount of a droplet to be discharged at one time is changed by performing simple control. Also, since the voltage application times Δt1 and Δt2 are set according to the time constants τ1 and τ2, respectively, efficient design is achieved.

### Second Embodiment

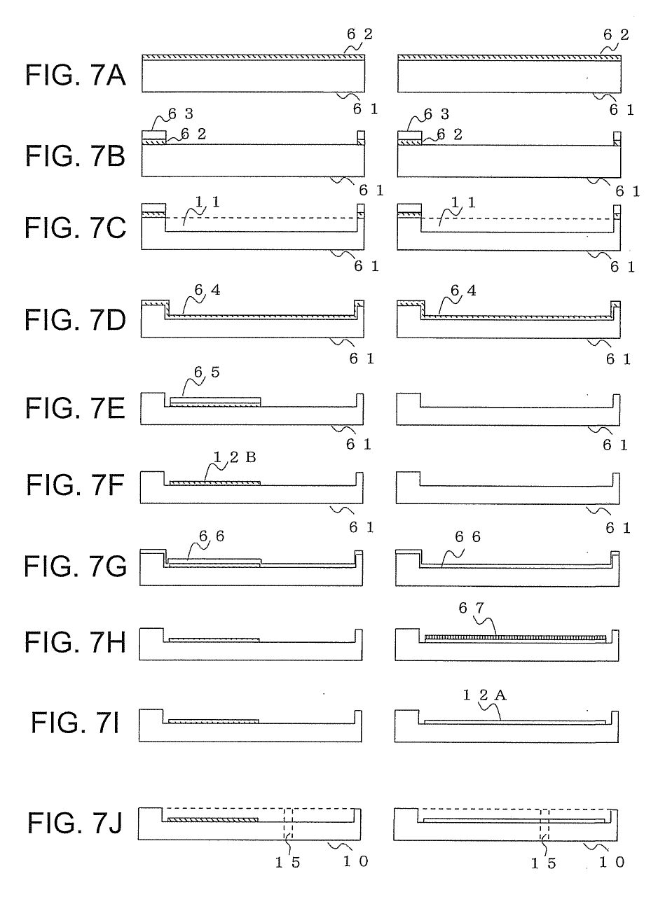

FIGS. 7A to 7J are drawings showing a process of manufacturing the electrode substrate 10. A method for manufacturing a droplet discharge head according to a second embodiment of the invention will now be described focusing on manufacture of the electrode substrate 10. The drawings on the right hand side represent a section in the long side direction of a portion in which the first individual electrode 12A and the like are formed, and the drawings on the left hand side represent a section in the long side direction of a portion in which the second individual electrode 12B is formed. Actually, multiple electrode substrates 10 are simultaneously formed using a wafer-shaped glass substrate. Then, the electrode substrates and other substrates are bonded together and then cut into individual droplet discharge heads. FIGS. 7A to 7J show only a part of the electrode substrate 10 of one droplet discharge head (the same goes for the following drawings).

Chrome (Cr) or the like is deposited on one surface of a glass substrate 61 with a thickness of approximately 1 mm so as to form a film 62 (hereafter referred to as a “mask film 62”) that will serve as a mask (Fig. A). The mask film 62 is formed, for example, by physical vapor deposition (PVD). Among PVD techniques are sputtering, vacuum deposition, and ion-plating. A photoresist 63 is applied to all of a surface of the mask film 62. Then, photolithography is performed. Specifically, the photoresist photosensitive resin applied to all of the surface of the chrome film is exposed to light using a mask aligner and developed using a developer. As a result, a pattern of the photoresist 63 for forming a portion that will become the recess 11 of the electrode substrate 10 later is formed on the glass substrate 61.

After the photoresist pattern is formed, wet-etching is performed using a cerium nitrate ammonium solution so as to eliminate an unnecessary portion of the mask film 62 (FIG. 7B). Thus, an etching pattern of a portion of the mask film 62 that will become the recess 11 is formed on the glass substrate 61. Then, the glass substrate 61 is wet-etched using a ammonium fluoride solution so as to form the recess 11 having a sidewall with a height of approximately 0.3 μm (FIG. 7C). Then, the mask film 62 is peeled off.

Then, titanium is deposited on, for example, all of the surface on which the recess 11 is formed, so as to form a film 64 (hereafter referred to as a “titanium film 64”) (FIG. 7D). The titanium film 64 is formed, for example, a PVD technique such as sputtering. A photoresist 65 is applied to the titanium film 64 using the above-described photolithography technique, and then patterned. Subsequently, the titanium film 64 is dry-etched using sulfur hexafluoride (SF₆) (FIG. 7E). Then the photoresist 65 is peeled off to form the second individual electrode 12B and connector 12C (FIG. 7F).

Further, ITO is deposited on all of the surface on which the recess 11 is formed, so as to form a film 66 (hereafter referred to as a “ITO film 66”) that will become the first individual electrode 12A, lead 13 and terminal 14 (FIG. 7G). While the method for forming the ITO film is not limited to a particular one, the ITO film is formed, for example, by sputtering. A photoresist 67 is applied to the ITO film 66 by photolithography and then patterned. Subsequently, the ITO film 66 is wet-etched using a mixed liquid of hydrochloric acid, nitric acid, and pure water (FIG. 7H). Then, the photoresist 67 is peeled off to form the first individual electrode 12A, lead 13, and terminal 14 (FIG. 7I). Then, the liquid supply inlet 15 is made. Thus, the electrode substrate 10 is manufactured (FIG. 7J). Here, taking into account damages due to etching, the second individual electrode 12B and connector 12C are formed using titanium, and then the first individual electrode 12A, lead 13, and terminal 14 are formed using ITO. Depending on the material of each electrode, etching method, etchant, or the like, the order in which these components are formed is limited thereto.

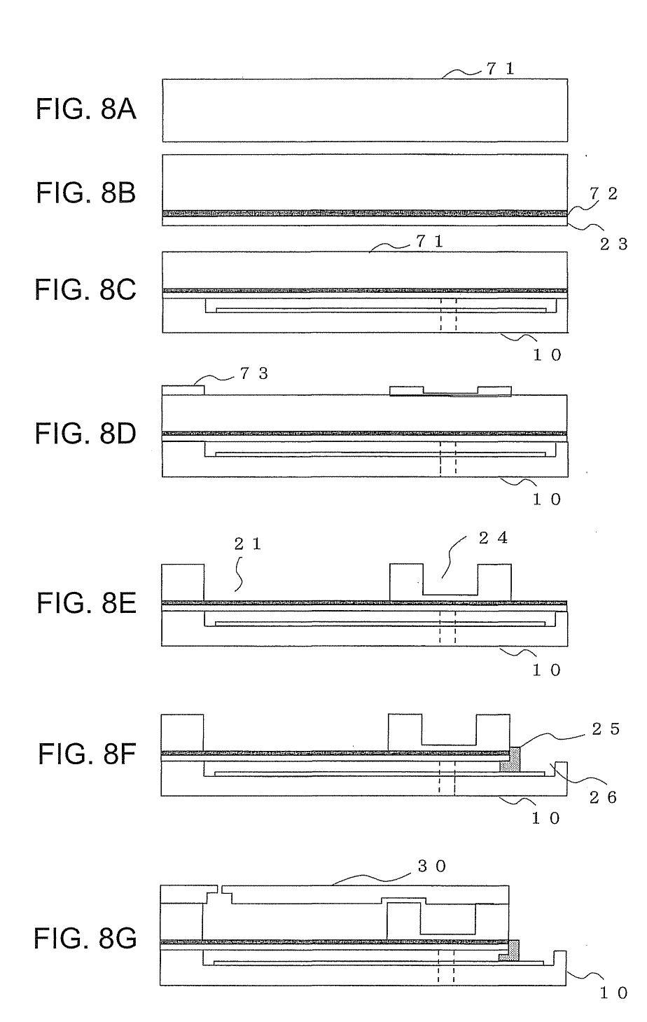

FIGS. 8A to 8G are drawings showing a process of manufacturing the droplet discharge head. The process of manufacturing the droplet discharge head will now be described with reference to FIGS. 8A to 8G. While multiple droplet discharge heads are simultaneously formed using one wafer, FIGS. 8A to 8G show only one droplet discharge head.

One surface (surface to which the electrode substrate 10 is to be bonded) of a silicon substrate 71 is mirror-polished to form a substrate (that will become the cavity substrate 20) with a thickness of, for example, 220 μm (FIG. 8A). Subsequently, a surface of the silicon substrate 71 on which a boron dope layer 72 is to be formed is opposed to a diffusion source of a solid that contains B₂O₃ as a main ingredient. Then, the silicon substrate 71 is put into a vertical furnace so that boron is diffused through the silicon substrate 71. Thus, the boron dope layer 72 is formed. An insulating film 23 is formed in a thickness of 0.1 μm on the surface on which the boron dope layer 72 is formed, by plasma CVD under the conditions: processing temperature of 360° C., a high-frequency output of 250 W, a pressure of 66.7 Pa (0.5 Torr), gas flow rate (TEOS flow rate) of 100 cm³/min (100 sccm), and oxygen flow rate of 1000 cm³/min (1000 sccm).

Then, the silicon substrate 71 and electrode substrate 10 are heated up to 360° C., and then a negative electrode is coupled to the electrode substrate 10 and a positive electrode is coupled to the silicon substrate 71. Then, these substrates anodically bonded to each other by applying a voltage of 800 V therebetween. The surface of the silicon substrate 71 included in the anodically-bonded substrate (hereafter referred to as a “bonded substrate”) is polished until the thickness of the silicon substrate 71 becomes approximately 60 μm. Subsequently, in order to eliminate an affected layer, the silicon substrate 71 is wet-etched using a potassium hydroxide solution for approximately 10 min. Thus, the thickness of the silicon substrate 71 is made approximately 50 μm (FIG. 8C).

Silicon oxide using TEOS is deposited on the wet-etched surface of the bonded substrate by plasma CVD, so as to form a hard mask (hereafter referred to as a “TEOS hard mask”) 73. The hard mask is formed in a thickness of 1.5 μm under the conditions: processing temperature of 360° C., a high-frequency output of 700 W, a pressure of 33.7 Pa (0.25 Torr), gas flow rate (TEOS flow rate) of 100 cm³/min (100 sccm), and oxygen flow rate of 1000 cm³/min (1000 sccm).

After the TEOS hard mask 73 is formed, resist-patterning is performed to wet-etch portions of the TEOS hard mask 73 that will become the discharge room 21 and electrode inlet 26. Then, using a hydrofluoric acid solution, these portions are wet-etched until the TEOS hard mask 73 is eliminated. Thus, the TEOS hard mask 73 is patterned and the silicon substrate 71 is exposed. With regard to a portion that will become reservoir 24, the TEOS hard mask 73 is slightly left to secure the thickness of the bottom of the reservoir 24. Also, with regard to a portion that will become the electrode inlet 26 which is fragile, the thickness of the resist may be slightly secured to prevent a fracture in a later step. Then, wet-etching is performed and then the resist is peeled off (FIG. 8D).

Subsequently, the bonded substrate is immersed into a potassium hydroxide solution with a concentration of 35 wt/%. Then wet-etching is performed until the thicknesses of portions that will become the discharge room 21 and electrode inlet 26 become approximately 10 μm. Further, the bonded substrate is immersed into a potassium hydroxide solution with a concentration of 3 wt/%, and then wet-etching is continued until the boron dope layer 72 is exposed and it is determined that an etching stop at which the progress of the etching becomes extremely slow has taken effect sufficiently (FIG. 8E). By performing etching using the two potassium hydroxide solutions having different concentrations in this way, surface roughness of a portion that will become the diaphragm 22 of the discharge room 21 is suppressed, thereby improving the thickness accuracy. As a result, the discharge performance of the droplet discharge head is stabilized.

When the wet-etching is complete, the bonded substrate is immersed into a hydrofluoric acid solution, and then the TEOS hard mask 73 on the surface of the silicon substrate 71 is peeled off. Subsequently, in order to eliminate a portion of the boron dope layer 72 that will become the electrode inlet 26, a silicon mask having an opening in a portion that will become the electrode inlet 26 is attached to the surface of the silicon substrate 71 included in the bonded substrate. For example, RIE dry-etching (anisotropic dry-etching) is performed for 30 min. under the conditions: RF power of 200 W, pressure of 40 Pa (0.3 Torr), and CF₄ flow rate of 30 cm³/min (30 sccm). Then, plasma is applied to only a portion that will become the electrode inlet 26, so as to make an opening. In order to improve the accuracy of alignment between the bonded substrate and mask, the silicon mask is preferably attached to the bonded substrate using pin alignment in which a pin is threaded through the bonded substrate and silicon mask. While the opening is made by anisotropic dry-etching herein, the boron dope layer 72 may be broken by puncturing it with a pin or the like. Then, sealing is performed using the sealing material 25 in order to shield the gap from an outside air (FIG. 8F). While the material of the sealing material 25, sealing method, and the like are not limited to particular ones, the sealing is performed, for example, by applying an epoxy resin to an opening of the electrode inlet 26 or depositing a silicon oxide thereon.

When the sealing is complete, a mask having an opening in a portion that will become the common electrode terminal 27 is attached to the surface of the silicon substrate 71 included in the bonded substrate. Then, sputtering or the like is performed using, for example, platinum (Pt) as a target so as to form the common electrode terminal 27. Then, the nozzle substrate 30 previously manufactured in another process is attached to the surface of the cavity substrate 20 included in the bonded substrate using an epoxy adhesive, and bonded thereto (FIG. 8G). Dicing is performed along dicing lines so that the bonded substrate is cut into individual droplet discharge heads. Thus, the droplet discharge heads are completed. Further, each droplet discharge head is coupled to the IC driver 48 via the wiring 49.

As described above, when manufacturing the electrode substrate 10, the second individual electrode 12B is formed using titanium and then the first individual electrode 12A is formed using ITO. Thus, these electrodes are formed without being damaged by each other.

### Third Embodiment

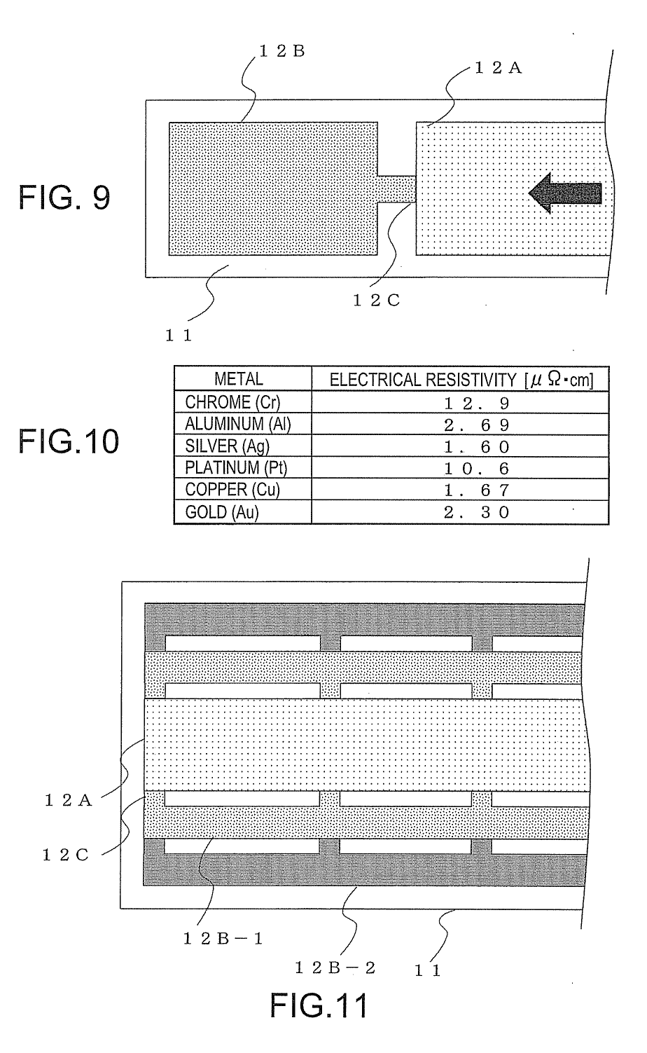

FIG. 9 is a partial enlarged view of the recess 11 and individual electrode 12 according to a third embodiment of the invention. While the first and second individual electrode 12A and 12B are provided side-by-side in the short side direction of the rectangular diaphragm 22 in the above-described embodiments, these electrodes may be provided side-by-side, for example, in the long side direction thereof. Also in this case, these electrodes may be electrically coupled to each other via the connector 12C so that the electric charge supply path is limited.

### Fourth Embodiment

FIG. 10 shows a table showing a typical electrical resistivity of each metal. In the above-described embodiments, ITO is used as the material of the first individual electrode 12A and titanium is used as the material of the second individual electrode 12B. While it is conceivable that titanium is most favorable in terms of the relations in electrical resistivity and the like with ITO, the material is not limited thereto. For example, adhesiveness to the glass that serves as a base of the electrode substrate 10 must be also considered. For example, chrome (Cr), platinum (Pt), gold (Au) and the like are conceivable as metal materials other than titanium. Further, other alloys, metal oxides such as titanium oxide, and the like may be used.

Also, the material of the first individual electrode 12A is not limited to ITO. For example, indium zinc oxide (IZO) and the like may be used as the material thereof.

FIG. 11 is a partial enlarged view of the recess 11 and individual electrode 12. In the above-described embodiments, the first individual electrode 12A is provided in the center of the recess 11 and the second individual electrode 12B is provided on both sides of the first individual electrode 12A. However, the invention is not limited thereto and, for example, a second individual electrode 12B-2 made of a different material may additionally be provided outside a second individual electrode 12B-1, as shown in FIG. 11. Also, in the above-described embodiments, titanium is used as the material of the connector 12C like the second individual electrode 12B. However, the invention is not limited thereto and a different material may be used.

### Fifth Embodiment

While the three-layered droplet discharge head including the electrode substrate 10, cavity substrate 20, and nozzle substrate 30 has been described in the above-described embodiments, the invention is also applicable to a four-layered droplet discharge head including an independent substrate (hereafter referred to as a “reservoir substrate”) as a reservoir.

### Sixth Embodiment

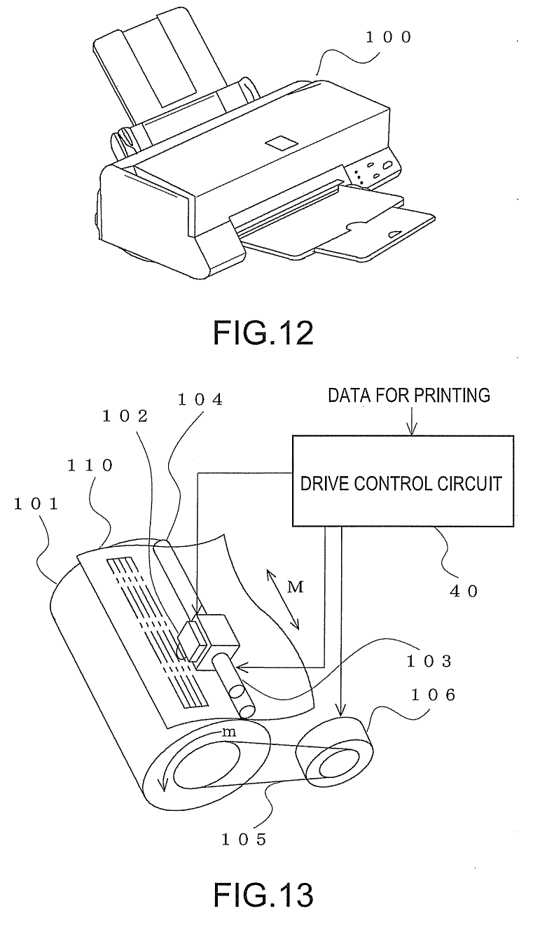

FIG. 12 is an outline view of a droplet discharge apparatus using a droplet discharge head manufactured according to the above-described embodiments. FIG. 13 is a drawing showing one example of the main components of the droplet discharge apparatus. The droplet discharge apparatus shown in FIGS. 12 and 13 is intended to perform printing using the droplet discharge method (inkjet method). Such a apparatus is called “serial type” apparatus. In FIG. 13, the droplet discharge apparatus mainly includes a drum 101 for supporting printing paper 110 as a printing target and a droplet discharge head 102 for discharging ink onto the printing paper 110 to perform recording. Although not shown, the droplet discharge apparatus also includes an ink supply means for providing ink to the droplet discharge head 102. The printing paper 110 is held by the drum 101 in a manner that it is pressed against the drum 101 by a paper pressure roller 103 provided in parallel to the axis direction of the drum 101. A lead screw 104 is provided in parallel to the axis direction of the drum 101, and the droplet discharge head 102 is held by the lead screw 104. By rotating the lead screw 104, the droplet discharge head 102 is moved in the axis direction of the drum 101.

On the other hand, the drum 101 is rotary-driven by a motor 106 via a belt 105 and the like. The drive control circuit 40 drives the lead screw 104 and motor 106 according to printing data and a control signal. Further, the drive control circuit 40 drives an oscillation drive circuit (not shown) to vibrate the diaphragm 22, and performs control so that printing is performed on the printing paper 110.

While ink is discharged onto the printing paper 110 in this embodiment, the liquid to be discharged from the droplet discharge head is not limited to ink. For example, the following liquids may be discharged from the droplet discharge head provided in a relevant droplet discharge apparatus: a liquid that includes a pigment for a color filter and is to be discharged onto a substrate which will become a color filter; a liquid that includes a compound which will become a light-emitting element and is to be discharged onto a display such as OLED; and a liquid that includes, for example, a conductive metal and is used to install wiring on a substrate. Also, a liquid including a probe such as deoxyribo nucleic acids (DNA), other nucleic acids (e.g., ribo nucleic acids, peptide nucleic acids, etc.), or a protein may be discharged from a dispenser as a droplet discharge head onto a substrate that will become a microarray of biomolecules. Further, the droplet discharge head may be used to discharge a dye for cloth.

What is claimed is:

1. A droplet discharge head comprising:
a nozzle discharging a liquid as a droplet;
a discharge room having a diaphragm and disposed in a channel of the liquid, the channel communicating with the nozzle, the diaphragm pressurizing the liquid by being displaced and being a part of the discharge room; and
a fixed electrode facing the diaphragm and generating electrostatic force with respect to the diaphragm by receiving electric charge so as to displace the diaphragm by bringing the diaphragm into contact with and detaching the diaphragm from the fixed electrode,
wherein the fixed electrode includes: a first fixed electrode received the electric charge from an outside; and a second fixed electrode made of a material different from a material of the first fixed electrode and received the electric charge through the first fixed electrode.

2. The droplet discharge head according to claim 1, wherein
the first and second fixed electrodes are electrically coupled to each other via a connector that serves as an electric charge supply path from the first fixed electrode to the second fixed electrode.

3. The droplet discharge head according to claim 1, wherein
the second fixed electrode is made of a material having an electrical resistivity higher than an electrical resistivity of a material of the first fixed electrode.

4. The droplet discharge head according to claim 1, wherein
indium tin oxide (ITO) is used as a material of the first fixed electrode and titanium is used as a material of the second fixed electrode.

5. The droplet discharge head according to claim 4, wherein
chrome, platinum, or gold is used as a material of the second fixed electrode instead of the titanium.

6. The droplet discharge head according to claim 1, wherein
the first fixed electrode is disposed in a central part in a short side direction of the discharge room and the second fixed electrode is disposed on both sides of the first fixed electrode, and the first fixed electrode and the second fixed electrode are provided side by side along the short side direction of the discharge room.

7. The droplet discharge head according to claim 6, wherein
a fixed electrode made of a material different from materials of the first and second fixed electrodes is further provided outside the second fixed electrode in the short side direction of the discharge room.

8. The droplet discharge head according to claim 1, wherein
the first fixed electrode and the second fixed electrode are provided side by side along a long side direction of the discharge room.

9. A droplet discharge apparatus comprising
the droplet discharge head according to claim 1.

10. A discharge control method for a liquid discharge head including: a nozzle discharging a liquid as a droplet; a discharge room having a diaphragm and disposed in a channel of the liquid, the channel communicating with the nozzle, the diaphragm pressurizing the liquid by being displaced and being a part of the discharge room; and a fixed electrode facing the diaphragm and generating electrostatic force with respect to the diaphragm by receiving electric charge so as to displace the diaphragm by bringing the diaphragm into contact with and detaching the diaphragm from the fixed electrode, the fixed electrode including a first fixed electrode received the electric charge from an outside and a second fixed electrode that is made of a material different from a material of the first fixed electrode and received the electric charge through the first fixed electrode, the method comprising:
controlling a time during which a voltage is applied by supplying electric charge to the fixed electrode, so that an area of contact of the diaphragm with the fixed electrode is changed.

11. The discharge control method for a droplet discharge head according to claim 10, wherein
a time during which a voltage is applied between the diaphragm and the fixed electrode is set according to respective time constants of the first and second fixed electrodes related to accumulation of electricity.
